(19) United States
(12) Patent Application Publication
(10) Pub. No.: US 2012/0135124 A1
(43) Pub. Date: May 31, 2012

(54) JUICE BEVERAGES

(75) Inventors: Stephen A. Letourneau, Cos Cob, CT (US); Rashmi Tiwari, White Plains, NY (US)

(73) Assignee: TROPICANA PRODUCTS, INC., Bradenton, FL (US)

(21) Appl. No.: 12/956,940

(22) Filed: Nov. 30, 2010

(51) Int. Cl. A23L 2/02

(52) U.S. Cl. 426/599

(57) ABSTRACT

A juice beverage including at least one liquid derived from one or more fruits and/or one or more vegetables, and solids derived from one or more fruits and/or one or more vegetables, where the solids and liquids are derived from distinct fruits or vegetables from each other. The taste of the beverage is identifiable as at least the fruits or vegetables from which the solids are derived, as determined by a sensory panel. In contrast, the appearance of the beverage may be identifiable as juice of at least the fruits or vegetables from which the liquid is derived. Alternatively, the taste is identifiable as at least the fruits or vegetables from which the liquid is derived while the appearance is identifiable as the juice of the fruits or vegetables from which the solids are derived. The juice beverage optionally has a brix of between about 3 and 16 degrees and may meet the standard of identity of a 100% juice.

### FIELD OF THE INVENTION

This invention relates to novel juice beverages that have unexpected taste, due to the combination of such ingredients as liquid derived from a fruit or vegetable and solids derived from a different fruit or vegetable than the liquid.

### BACKGROUND

Beverages of various improved and new formulations are desirable to achieve desired nutritional characteristics, flavor, shelf life, and other advantages. For example, currently, juices comprise a single juice derived from a fruit or vegetable, or a combination of juices derived from a plurality of distinct fruit(s) and vegetable(s). Further, current juices comprise varying amounts of solids supplied by pulp, membranes, and the like. Certain juices have pulp and other solids removed, while others have extra pulp and solids added, depending on the consumer preference.

One drawback to certain juices, especially fruit juices, is that they can comprise a large amount of carbohydrates, in particular sugars. It would be desirable to provide a juice beverage that comprises a low total amount of sugars, for example for consumers concerned with their total carbohydrate intake. It would further be desirable to provide a low carbohydrate juice that is made entirely from fruit and/or vegetable components. For instance, a juice beverage containing water to dilute the amount of carbohydrates will not meet the standard of identity of a 100% juice or a not from concentrate (NFC) juice. Accordingly, it would be advantageous to provide a low carbohydrate juice beverage that contains only fruit or vegetable components, in order to meet the desired juice standard(s) of identity.

It would also be desirable to provide an economical juice beverage by combining an inexpensive juice as the bulk of the juice beverage with a small amount of a more expensive distinct fruit or vegetable component. It would also be desirable to provide a unique juice beverage experience for consumers by combining distinct fruit or vegetable components, such that the juice beverage appears to be one juice, yet tastes like a different juice.

It is an advantage of the invention to provide beverages and other beverage products having desirable appearance, taste and health properties. It is an advantage of at least certain embodiments of the invention to provide juice beverages having improved formulations, including low carbohydrate content. It is another advantage of the invention to provide economical juice beverages. It is a further advantage of the invention to combine components derived from one or more distinct fruits and vegetables to provide products having unique taste profiles and appearances. These and other advantages and features of the invention or of certain embodiments of the invention will be apparent to those skilled in the art from the following disclosure and description of exemplary embodiments.

### SUMMARY

In accordance with one aspect, a juice beverage is provided comprising at least one liquid derived from one or more fruits, one or more vegetables and combinations thereof; and solids derived from one or more fruits, one or more vegetables, and combinations thereof, wherein the solids are derived from fruits or vegetables distinct from the fruits or vegetables from which the liquid is derived. The taste of the beverage is identifiable as at least the fruits or vegetables from which the solids are derived, as determined by a sensory panel. In contrast, the appearance of the beverage may be identifiable as a juice of at least the fruits or vegetables from which the liquid is derived. The juice beverage may have a brix of between about 3 and 16 degrees. Optionally, the juice beverage meets the standard of identity of a 100% juice.

In accordance with another aspect, a juice beverage is provided comprising a juice selected from a fruit juice and a vegetable juice; and solids obtained from a fruit or a vegetable, wherein the solids are obtained from a fruit or vegetable distinct from the fruit juice and the vegetable juice. The taste of the beverage is identifiable as at least the fruit or vegetable from which the solids are obtained, as determined by a sensory panel.

In accordance with a further aspect, a method is provided or making a beverage composition comprising combining at least one liquid derived from one or more fruits, one or more vegetables, and combinations thereof; and solids derived from one or more fruits, one or more vegetables, and combinations thereof, wherein the solids are derived from one or more fruits or one or more vegetables distinct from the one or more fruits and one or more vegetables from which the liquid is derived. The taste of the beverage is identifiable as at least the one or more fruits or one or more vegetables from which the solids are derived, as determined by a sensory panel.

In a still further aspect, a juice beverage is provided comprising at least one liquid derived from one or more fruits, one or more vegetables and combinations thereof; and solids derived from one or more fruits, one or more vegetables, and combinations thereof, wherein the solids are derived from fruits or vegetables distinct from the fruits or vegetables from which the liquid is derived. The taste of the beverage is identifiable as at least the fruits or vegetables from which the liquid derived, as determined by a sensory panel. In contrast, the appearance of the beverage may be identifiable as a juice of at least the fruits or vegetables from which the solids are derived.

It will be appreciated by those skilled in the art, given the benefit of the following description of certain exemplary embodiments of the juice beverage and other juice beverage products disclosed here, that at least certain embodiments of the invention have improved or alternative formulations suitable to provide desirable taste profiles, nutritional characteristics, etc. These and other aspects, features and advantages of the invention or of certain embodiments of the invention will be further understood by those skilled in the art from the following description of exemplary embodiments.

### DETAILED DESCRIPTION OF EMBODIMENTS

Juice beverages are popular with consumers for numerous reasons, such as their nutrients, taste, and convenience as compared to the amount of preparation often involved when consuming whole fruits or vegetables. However, not all consumers prefer the taste of certain fruits and vegetables and are thus less likely to ingest the nutrients provided by those fruits and vegetables. It is an advantage of the current invention to provide juice beverages comprising distinct fruits and/or vegetables that include the nutrients of all of the fruits or vegetables present in the juice beverage, but the taste of only some of the fruits or vegetables present in the juice beverage. In certain embodiments, the juice beverage comprises a full serving of vegetables, a full serving of fruits, or a combination thereof, per 8 ounce serving.

The juice beverages according to the present invention comprise at least a liquid component and a solids component. The liquid component, derived from one or more fruits, one or more vegetables, and combinations thereof, comprises any liquid that may be obtained from a particular fruit or vegetable. The liquid may be, for example and without limitation, a juice, a serum, a juice concentrate, a clarified juice, a single strength juice, a not from concentrate juice, a fruit or vegetable water, and combinations thereof. In certain embodiments, the liquid does not exhibit a significant flavor. In alternate embodiments, the liquid provides the identifiable flavor of the juice beverage. In certain embodiments, the liquid provides one of a plurality of identifiable flavors in the juice beverage.

As used herein, the term “identifiable” with respect to one or more fruits and/or vegetables is defined as the taste, or the scent, or the feel, or the appearance, or combinations thereof, of the juice beverage being determined to be recognizable as at least one fruit and/or vegetable by a trained sensory panel. Sensory panels are well known in the art, and comprise groups of trained testers who describe products on the basis of selected senses, such as taste, scent, feel, sound, and appearance.

The solids component, derived from one or more fruits, one or more vegetables, and combinations thereof, comprises any solid that may be obtained from a particular fruit or vegetable. In general, the solids may comprise edible parts that are normally extracted from a fruit or vegetable into juice, solids that are typically discarded during juice processing (e.g., solids removed during clarification of a juice), and combinations thereof. When the solids are present in combination with a liquid such as juice, the solids may be isolated using any suitable separation technology, including for example and without limitation, centrifugation, decantation, filtration, nano-filtration, and ultra-filtration. The solids may be, for example and without limitation, sensible solids, sinking solids, vesicles, finisher-derived solids, pulp, sacs, pericarp, membranes, cellulosic materials, homogenized pulp, pomace, peel, and combinations thereof.

Surprisingly, it was discovered that components that provide flavor may remain associated with solids derived from fruits and vegetables following separation of the solids from the fruit or vegetable. In particular, the combination of an amount of such solids with certain liquids derived from other fruits and/or vegetables resulted in juice beverages exhibiting a taste identifiable with at least the fruits and/or vegetables from which the solids were derived. In certain embodiments, the volume ratio of liquid to solids is between about 2:1 and about 30:1, or between about 5:1 and about 10:1. In an alternate embodiment, the solids exhibit a mild or bland taste and the juice beverage exhibits a taste identifiable with at least the fruits and/or vegetables from which the liquid was derived. In such an embodiment, preferably the appearance of the juice beverage is identifiable as a juice of at least the fruit and/or vegetables from which the solids were derived.

Solids derived from fruits and vegetables advantageously provide macro nutrition, micro nutrition, or combinations thereof, to compositions according to embodiments of the invention. As used herein, the term “macro nutrition” refers to components that provide nutrients in a relatively large amount, for example and without limitation, protein, carbohydrates, fat, fiber, and combinations thereof. As used herein, the term “micro nutrition” refers to components that provide nutrition in relatively small amounts, for example and without limitation, vitamins, electrolytes, minerals, trace minerals, phytonutrients such as flavonoids, carotenoids, and combinations thereof. For example and without limitation, the solids may provide fiber, vitamins such as vitamin C and vitamin A, flavonoids, carotenoids such as lycopene, and combinations thereof. Accordingly, the macro nutrition, the micro nutrition, or both, of a composition in embodiments of the invention may be manipulated by selecting solids derived from a specific fruit, vegetable, or combinations thereof, and incorporating the solids into the composition in a predetermined quantity. For instance, when it is desired to provide a composition comprising flavonoids, citrus solids may be included in the composition. Moreover, when a particular level of fiber is desired for a composition, the amount of solids added may be selected to provide that quantity of fiber, depending on the fiber content of the type of solids being added.

Juice beverages containing 100% juice are popular with consumers for numerous reasons, such as their nutritional profile and lack of added water. These juice beverages must meet particular standard of identity criteria. The US Food and Drug Administration sets a standard for food labeling, including juice labeling. 21 CFR Section 101.30 states that beverages containing “100 percent juice and non-juice ingredients that do not result in a diminution of the juice soluble solids or, in the case of expressed juice, in a change in the volume, when the 100 percent juice declaration appears on a panel of the label that does not also bear the ingredient statement, it must be accompanied by the phrase “with added ______,” the blank filled in with a term such as “ingredient(s),” “preservative,” or “sweetener,” as appropriate (e.g., “100% juice with added sweetener”), except that when the presence of the non-juice ingredient(s) is declared as a part of the statement of identity of the product, this phrase need not accompany the 100 percent juice declaration.” Consequently, since solids derived from a fruit or a vegetable are ingredients included within the standard of identity of juice, the juice beverages of certain embodiments of the invention may be labeled as “100 percent juice.”

Similarly, not from concentrate (NFC) juices tend to be popular with consumers for numerous reasons, such as their fresh taste and nutritional profile. These NFC juices also must meet particular standard of identity criteria. Among these criteria are brix minimums and brix-to-acid ratio minimums. For example, the US Food and Drug Administration sets a standard for juices such as orange juice. In this regard 21 CFR Section 146.140, incorporated by reference hereinto, states that finished pasteurized orange juice is to contain not less than 10.5 percent by weight of orange juice soluble solids, exclusive of the solids of any added sweetening ingredients. This FDA regulation further states that the ratio of brix to grams of citric acid per 100 ml of juice is not less than a 10 to 1 ratio. The juice industry recognizes these criteria for pasteurized orange juice or single strength orange juice as applying to NFC orange juice. It will be understood that these standard of identity criteria are used herein with respect to NFC orange juice or pasteurized single strength orange juice. This same concept of standard of identity criteria applies as well to other pasteurized single strength juices. In certain embodiments, the juice beverages according to the current invention meet the criteria of NFC juice.

In certain embodiments, a juice beverage is provided that comprises liquid derived from one or more fruits and/or vegetables and solids derived from one or more fruits and/or vegetables distinct from the source of the liquid. It was unexpected that a juice beverage having a taste identifiable with the at least one or more fruits, one or more vegetables, or combinations thereof, from which the solids were derived could be provided despite the presence of the liquid derived from one or more other distinct fruits or vegetables. The solids also provide fiber to the juice beverage, which can result in a greater feeling of satiety following consumption of the beverage, as compared to a typical juice beverage, and can better mimic the total nutritional benefit of eating whole fruit vs. juice.

Moreover, it was surprising to be able to provide a juice beverage having an appearance identifiable with at least the one or more fruits, one or more vegetables, or combinations thereof, from which the liquid was derived, having a taste that was identifiable with the solid source fruits and/or vegetables instead of the liquid source fruits and/or vegetables.

It is also an advantage of certain aspects of the invention to provide an economical juice beverage comprising a combination of an inexpensive liquid as the bulk of the juice beverage with a small amount of a more expensive, distinct fruit or vegetable component.

In certain embodiments, the juice beverage is a low carbohydrate or low sugar beverage, comprising a brix of between about 3 degrees and about 16 degrees. As used herein, the term “brix” refers to the percent of sucrose by weight, in grams per 100 milliliters of liquid. In other embodiments, the juice beverage comprises a brix of between about 4 degrees and about 12 degrees, or between about 5 degrees and about 10 degrees, or between about 6 degrees and about 8 degrees. In certain aspects of the invention, the juice beverage provides less than 100 calories per 8 ounce serving. In an embodiment of the invention, the juice beverage provides less than 80 calories per 8 ounce serving, or less than 70 calories per 8 ounce serving, or less than 60 calories per 8 ounce serving, or less than 50 calories per 8 ounce serving.

Liquids derived from one or more fruits, one or more vegetables, and combinations thereof, are a basic ingredient in the juice beverages disclosed here, typically being the vehicle or primary liquid portion in which the remaining ingredients are dissolved, emulsified, suspended or dispersed. Liquids suitable for use in at least certain exemplary embodiments of the beverage products disclosed here include, e.g., fruit, vegetable and berry juices. Liquids can be employed in the present invention in the form of a single-strength juice, NFC juice, 100% pure juice, juice concentrate, serum, clarified juice, fruit or vegetable water, clarified serum, or other suitable forms. The term “clarified” as used herein refers to a liquid that has had the solid matter removed using filtration or centrifugation. Typically, the filtration comprises removing solid matter as small as 0.1 microns in diameter. The term “serum” as used herein refers to the thin, clear portion of the fluid of plants, such as fruits or vegetables. The term “water” as used herein refers to the clear liquid extracted from fruits or vegetables. The term “juice” as used herein includes single-strength fruit (including berry) or vegetable juice, as well as concentrates, milks, and other forms. Multiple liquids derived from different fruits and/or vegetables can be combined to generate a juice beverage having the desired nutrients.

Examples of suitable liquid sources include, without limitation, orange, lemon, lime, tangerine, mandarin orange, tangelo, pomelo, grapefruit, grape, red grape, sweet potato, tomato, celery, beet, lettuce, spinach, cabbage, watercress, rhubarb, carrot, cucumber, raisin, cranberry, pineapple, peach, banana, apple, pear, guava, apricot, watermelon, Saskatoon berry, blueberry, plains berry, prairie berry, mulberry, elderberry, Barbados cherry (acerola cherry), choke cherry, date, coconut, olive, raspberry, strawberry, huckleberry, loganberry, currant, dewberry, boysenberry, kiwi, cherry, blackberry, quince, buckthorn, passion fruit, sloe, rowan, gooseberry, pomegranate, persimmon, mango, rhubarb, papaya, lychee, plum, prune, date, currant, fig, etc. Numerous additional and alternative liquids derived from fruits or vegetables suitable for use in at least certain exemplary embodiments will be apparent to those skilled in the art given the benefit of this disclosure.

In certain embodiments of the invention, liquids comprising low amounts of carbohydrates may be employed in juice beverages. An advantage of low carbohydrate juice beverages according to the invention is the ability to provide lower calorie beverages comprising nutrients from fruits and/or vegetables without including any added water. For instance, Table 1 below shows the number of calories typically provided by exemplary liquids.

TABLE 1
Calories per 8 ounce serving

| Liquid | Calories per 8 oz. |
|---|---|
| Celery Juice | 30 |
| Tomato Water | 50 |
| Coconut Water | 50 |
| Watermelon Juice | 80 |
| Carrot Juice | 80 |
| Grapefruit Juice | 80 |

As noted above, the solids derived from one or more fruits, one or more vegetables, and combinations thereof, may be provided by sensible solids, sinking solids, vesicles, finisher-derived solids, pulp, sacs, pericarp, membranes, cellulosic materials, homogenized pulp, pomace, peel, and combinations thereof. In certain embodiments of the invention, the solids comprise materials that exhibit strong or intense flavor, in order to impart the identifiable flavor associated with the selected solids to the juice beverage. For example, orange solids and tomato solids provide significant flavor to juice beverages in which they are employed. In addition to providing specific taste or flavor, the solids may also add minor components such as polyphenols (for instance flavonoids), vitamins, color, and the like. It will be appreciated by one of skill in the art that the physical conditions, chemical conditions and combinations thereof to which the solids are subjected during preparing compositions according to embodiments of the invention may affect components associated with the solids. For instance, homogenization of solids may disrupt the natural association of limonene to orange solids. In addition, certain heating methods for treating tomatoes can alter the association of lycopene with the solid or liquid portion of the tomatoes.

In alternate aspects, the solids comprise materials that exhibit moderate to low flavor, to impart a less intense flavor thereby allowing a blend of flavors from multiple components. Moreover, moderate flavored solids may be included to provide particular nutrients to the juice beverage. For example, grapefruit solids provide only minor flavor to juice beverages in which they are employed.

Juice pulp typically comprises particles of the soft, fleshy part of the fruit or vegetable, which has been removed from the fruit or vegetable along with the juice during extraction. For instance, citrus pulp may include fruit vesicles that contain juice, or fragments of fruit vesicles or membranes. Sinking pulp or sinking solids are solids that are obtained by centrifuging a juice to separate out the solids. Sinking pulp and sinking solids from orange juice provide higher color and higher flavor than pulp or other orange solids that have been subjected to further processing, for instance homogenization.

According to certain embodiments of the invention, homogenized pulp, such as citrus pulp, may be employed as the solids, and may contain more than one citrus varietal to provide a specific selected flavor profile. Homogenization of fruit or vegetable pulp will decrease the size of the pulp particles such that they are sufficiently small to provide a homogeneous mouthfeel and very slowly settle out of suspension. For example, suspended homogenized pulp typically settles to the bottom of the juice beverage within about 24-32 hours. Homogenized pulp may be prepared using a variety of processes, such as using methods disclosed in U.S. Pat. No. 4,690,827. In this patent, a method is described in which a pulp slurry is passed through a homogenizer at high pressure to reduce the average size of the pulp particles. Numerous homogenizer settings may be successfully used to decrease the pulp particle size, such as operating the homogenizer at a pressure of at least 19 MPa. Alternatively, the homogenizer may be a two stage homogenizer and operated at a slurry volume rate of rate 6500 liters per hour, at 25 MPa during the first stage and 5 MPa during the second stage, as described in U.S. Pat. No. 4,690,827.

Homogenized pulp may also be prepared by grinding pulp, for example as disclosed in U.S. Pat. No. 5,162,128. Pulp, optionally dried pulp, may be reduced such that the particles have a diameter of less than about 1000 microns, and at least 50% of the particles have a size less than 700 microns, preferably less than about 500 microns. This process employs a carrier-gas-swept jet mill configured to have an internal design and feed rate sufficient to grind the pulp to the desired particle size distribution, followed by an air-solid separation. The homogenized pulp according to embodiments of the invention may have an approximate particle size diameter between about 40 microns and about 700 microns.

In alternative embodiments, juice beverages may be prepared that are not 100% juice. For example, juice beverages may comprise from concentrate (FC) juice, which is juice that has been previously concentrated to remove water, and then diluted to provide at least a minimum specified Brix, depending on the type of juice. Orange juice, for instance, must have a minimum Brix level of 11.8, while grapefruit juice must have a minimum Brix level of 10.0. Further embodiments include juice beverages comprising reduced calorie, light, or low-calorie juice. Such beverages typically comprise juice, added water, and often other added ingredients to provide a desired taste, such as non-nutritive sweeteners.

In certain embodiments, a juice beverage is provided that comprises liquid and finisher-derived solids. The term “finisher-derived solids” as used herein refers collectively to solids removed from juice that has been extracted from fruits and/or vegetables. Such solids may include, without limitation, material from peel, seeds, membranes, cellulosic materials and sensible pulp such as bitable fruit pulp, fruit vesicles, and/or fruit sac, which are typically removed from the juice in a finishing step. Often, the separation of solids during the extraction process results in a slurry having a consistency similar to applesauce, which is obtained from the finisher, which is commonly referred to as the “tight end”. Suitable finishers are available from Brown International Corporation (Winter Haven, Fla.) or JBT Corporation (Chicago, Ill.). The finisher-derived solids may be homogenized via high shear homogenization or grinding methods as described above, to provide particle sizes below about 1500 μm, for instance between about 40 μm and about 1400 μm.

Homogenized finisher-derived solids may be included in a juice in a lower amount than other solids, for instance sinking pulp or homogenized pulp, due to the presence of some flavors that may have a negative impact, such as bitter flavors provided by peel and membrane solids. Accordingly, embodiments of the invention include juices comprising homogenized finisher-derived solids in an amount between about 15% by weight and about 40% by weight of the total juice beverage. An advantage to employing finisher-derived solids is that a juice beverage may be prepared using inexpensive juice extraction byproducts that might otherwise be disposed of as waste.

In certain embodiments, both pulp and homogenized finisher-derived solids are incorporated into juice beverages. The inclusion of both pulp and homogenized solids provides a combination of the advantages of both materials, as well as the opportunity to specifically select amounts and varietals of pulp and solids based on the characteristics of the materials.

To provide desirable flavor and mouthfeel of the juice beverage, the solids employed may comprise a blend of different solids. For instance, more than one type of solids derived from distinct fruits or vegetables may be combined in juice beverages of the current invention. In certain embodiments, when the solids are orange solids, they may comprise a blend of orange varietals to achieve a specific flavor profile.

It should be understood that juice beverages and other juice beverage products in accordance with this disclosure may have any of numerous different specific formulations or constitutions. In general, an NFC and/or 100% juice beverage in accordance with this disclosure typically comprises fruit or vegetable liquid and fruit or vegetable solids. The formulation of a beverage product in accordance with this disclosure can vary to a certain extent, depending upon such factors as the product's intended market segment, its desired nutritional characteristics, flavor profile and the like.

For example, it will generally be an option to add further ingredients to the formulation of a particular beverage embodiment, including any of the beverage formulations described below in particular if the juice beverage is not required to meet a specific standard of identity. Additional (i.e., more and/or other) sweeteners may be added, flavorings, inclusions (e.g., fruit or vegetable pieces, fiber, oat flour or nuts), electrolytes, vitamins, tastants, masking agents and the like, flavor enhancers, and/or carbonation typically can be added to any such formulations to vary the taste, mouthfeel, nutritional characteristics, etc.

In embodiments for which the juice beverage is not 100% juice or is from concentrate, water may instead be the vehicle or primary liquid portion in which the remaining ingredients are included. Purified water can be used in the manufacture of certain embodiments of the beverages disclosed here, and water of a standard beverage quality can be employed in order not to adversely affect beverage taste, odor, or appearance. The water typically will be clear, colorless, free from objectionable minerals, tastes and odors, free from organic matter, low in alkalinity and of acceptable microbiological quality based on industry and government standards applicable at the time of producing the beverage. In certain embodiments, water is present at a level of from about 1% to about 99.9% by weight of the beverage. In at least certain exemplary embodiments the water used in beverages and concentrates disclosed here is “treated water,” which refers to water that has been treated to reduce the total dissolved solids of the water prior to optional supplementation, e.g., with calcium as disclosed in U.S. Pat. No. 7,052,725. Methods of producing treated water are known to those of ordinary skill in the art and include deionization, distillation, filtration and reverse osmosis (“r-o”), among others. The terms “treated water,” “purified water,”, “demineralized water,” “distilled water,” and “r-o water” are understood to be generally synonymous in this discussion, referring to water from which substantially all mineral content has been removed, typically containing no more than about 500 ppm total dissolved solids, e.g. 250 ppm total dissolved solids.

Acid used in beverages disclosed here can serve any one or more of several functions, including, for example, providing antioxidant activity, lending tartness to the taste of the beverage, enhancing palatability, increasing thirst quenching effect, modifying sweetness and acting as a mild preservative by providing microbiological stability. Ascorbic acid, commonly referred to as “vitamin C”, is often employed as an acidulant in beverages to also provide a vitamin to the consumer. Any suitable edible acid may be used, for example citric acid, malic acid, tartaric acid, phosphoric acid, ascorbic acid, lactic acid, formic acid, fumaric acid, gluconic acid, succinic acid and/or adipic acid.

The acid can be used in solid or solution form, and in an amount sufficient to provide the desired pH of the beverage. Typically, for example, the one or more acids of the acidulant are used in amount, collectively, of from about 0.01% to about 1.0% by weight of the beverage, e.g., from about 0.05% to about 0.5% by weight of the beverage, such as 0.1% to 0.25% by weight of the beverage, depending upon the acidulant used, desired pH, other ingredients used, etc. The amount of acid in the gel beverage concentrate may range from about 1.0% to about 2.5%, between about 1.5% and about 2.0%, or about 1.8% by weight of the gel beverage concentrate. In certain embodiments of the invention, all of the acid included in a beverage composition may be provided by citric acid.

The pH of at least certain exemplary embodiments of the beverages disclosed here can be a value within the range of 2.5 to 4.0. The acid in certain exemplary embodiments can enhance beverage flavor. Too much acid can impair the beverage flavor and result in sourness or other off-taste, while too little acid can make the beverage taste flat and reduce microbiological safety of the product. It will be within the ability of those skilled in the art, given the benefit of this disclosure, to select a suitable acid or combination of acids and the amounts of such acids for the acidulant component of any particular embodiment of the beverage products disclosed here.

Sweeteners suitable for use in various embodiments of the beverages disclosed here include nutritive and non-nutritive, natural and artificial or synthetic sweeteners. In at least certain exemplary embodiments of the beverages disclosed here, the sweetener component can include nutritive, natural crystalline or liquid sweeteners such as sucrose, liquid sucrose, fructose, liquid fructose, glucose, liquid glucose, glucose-fructose syrup from natural sources such as apple, chicory, honey, etc., e.g., high fructose corn syrup, invert sugar, maple syrup, maple sugar, honey, brown sugar molasses, e.g., cane molasses, such as first molasses, second molasses, blackstrap molasses, and sugar beet molasses, sorghum syrup, Lo Han Guo juice concentrate and/or others. Typically, such sweeteners are present in a gel beverage concentrate in an amount of from about 0.5% to about 35% by weight, such as from about 15 to about 25% by weight. Further, such sweeteners are present in an amount of from about 0.1% to about 20% by weight of a finished beverage, such as from about 6% to about 16% by weight, depending upon the desired level of sweetness for the beverage. To achieve desired beverage uniformity, texture and taste, in certain exemplary embodiments of the natural beverage products disclosed here, standardized liquid sugars as are commonly employed in the beverage industry can be used. Typically such standardized sweeteners are free of traces of nonsugar solids which could adversely affect the flavor, color or consistency of the beverage.

Suitable non-nutritive sweeteners and combinations of sweeteners are selected for the desired nutritional characteristics, taste profile for the beverage, mouthfeel and other organoleptic factors. Non-nutritive sweeteners suitable for at least certain exemplary embodiments include, but are not limited to, for example, peptide based sweeteners, e.g., aspartame, neotame, and alitame, and non-peptide based sweeteners, for example, sodium saccharin, calcium saccharin, acesulfame potassium, sodium cyclamate, calcium cyclamate, neohesperidin dihydrochalcone, and sucralose. In certain embodiments the sweetener comprises acesulfame potassium. Other non-nutritive sweeteners suitable for at least certain exemplary embodiments include, for example, Stevia rebaudiana extracts, rebaudioside A, sorbitol, mannitol, xylitol, glycyrrhizin, D-tagatose, erythritol, meso-erythritol, maltitol, maltose, lactose, fructo-oligosaccharides, Lo Han Guo powder, xylose, arabinose, isomalt, lactitol, maltitol, trehalose, and ribose, and protein sweeteners such as thaumatin, monellin, brazzein, L-alanine and glycine, related compounds, and mixtures of any of them. Lo Han Guo, Stevia rebaudiana extracts, rebaudioside A, and monatin and related compounds are natural non-nutritive potent sweeteners.

Non-nutritive, high potency sweeteners typically are employed at a level of milligrams per fluid ounce of beverage, according to their sweetening power, any applicable regulatory provisions of the country where the beverage is to be marketed, the desired level of sweetness of the beverage, etc. It will be within the ability of those skilled in the art, given the benefit of this disclosure, to select suitable additional or alternative sweeteners for use in various embodiments of the beverage products disclosed here.

Preservatives may be used in certain embodiments of the beverages disclosed here. That is, certain exemplary embodiments contain an optional dissolved preservative system. Solutions with a pH below 4.6 and especially those below 3 typically are “microstable,” i.e., they resist growth of microorganisms, and so are suitable for longer term storage prior to consumption without the need for further preservatives. However, an additional preservative system can be used if desired. Furthermore, embodiments of juice beverages having low acidity generally comprise a preservative system. If a preservative system is used, it can be added to the beverage product at any suitable time during production, e.g., in some cases prior to the addition of the sweetener. As used here, the terms “preservation system” or “preservatives” include all suitable preservatives approved for use in food and beverage compositions, including, without limitation, such known chemical preservatives as benzoic acid, benzoates, e.g., sodium, calcium, and potassium benzoate, sorbates, e.g., sodium, calcium, and potassium sorbate, citrates, e.g., sodium citrate and potassium citrate, polyphosphates, e.g., sodium hexametaphosphate (SHMP), lauryl arginate ester, cinnamic acid, e.g., sodium and potassium cinnamates, polylysine, and antimicrobial essential oils, dimethyl dicarbonate, and mixtures thereof, and antioxidants such as ascorbic acid, EDTA, BHA, BHT, TBHQ, EMIQ, dehydroacetic acid, ethoxyquin, heptylparaben, and combinations thereof.

Preservatives can be used in amounts not exceeding mandated maximum levels under applicable laws and regulations. The level of preservative used typically is adjusted according to the planned final product pH, as well as an evaluation of the microbiological spoilage potential of the particular beverage formulation. The maximum level employed typically is about 0.05% by weight of the beverage. It will be within the ability of those skilled in the art, given the benefit of this disclosure, to select a suitable preservative or combination of preservatives for beverages according to this disclosure. In certain embodiments of the invention, sorbic acid or its salts (sorbates) may be employed as preservatives in the beverage products, such as in an amount of less than 0.1% by weight of a gel beverage concentrate.

Other methods of beverage preservation suitable for at least certain exemplary embodiments of the beverage products disclosed here, such as ready-to-drink beverages, include, e.g., aseptic packaging and/or heat treatment or thermal processing steps, such as hot filling and tunnel pasteurization. Such steps can be used to reduce yeast, mold and microbial growth in the beverage products. For example, U.S. Pat. No. 4,830,862 to Braun et al. discloses the use of pasteurization in the production of fruit juice beverages as well as the use of suitable preservatives in carbonated beverages. U.S. Pat. No. 4,925,686 to Kastin discloses a heat-pasteurized freezable fruit juice composition which contains sodium benzoate and potassium sorbate. In general, heat treatment includes hot fill methods typically using high temperatures for a short time, e.g., about 190° F. for 10 seconds, tunnel pasteurization methods typically using lower temperatures for a longer time, e.g., about 160° F. for 10-15 minutes, and retort methods typically using, e.g., about 250° F. for 3-5 minutes at elevated pressure, i.e., at pressure above 1 atmosphere.

The beverage products disclosed here optionally contain a flavoring composition, for example, natural and synthetic fruit flavors, botanical flavors, other flavors, and mixtures thereof. As used here, the term “fruit flavor” refers generally to those flavors derived from the edible reproductive part of a seed plant. Included are both those wherein a sweet pulp is associated with the seed, e.g., banana, tomato, cranberry and the like, and those having a small, fleshy berry. The term berry also is used here to include aggregate fruits, i.e., not “true” berries, but that are commonly accepted as a berry. Also included within the term “fruit flavor” are synthetically prepared flavors made to simulate fruit flavors derived from natural sources. Examples of suitable fruit or berry sources include whole berries or portions thereof, berry juice, berry juice concentrates, berry purees and blends thereof, dried berry powders, dried berry juice powders, and the like.

Exemplary fruit flavors include the citrus flavors, e.g., orange, lemon, lime and grapefruit, and such flavors as apple, pomegranate, grape, cherry, and pineapple flavors and the like, and mixtures thereof. In certain exemplary embodiments the beverage concentrates and beverages comprise a fruit flavor component, e.g., a juice concentrate or juice. As used here, the term “botanical flavor” refers to flavors derived from parts of a plant other than the fruit. As such, botanical flavors can include those flavors derived from essential oils and extracts of nuts, bark, roots and leaves. Also included within the term “botanical flavor” are synthetically prepared flavors made to simulate botanical flavors derived from natural sources. Examples of such flavors include cola flavors, tea flavors, and the like, and mixtures thereof. The flavor component can further comprise a blend of the above-mentioned flavors. The particular amount of the flavor component useful for imparting flavor characteristics to the beverages of the present invention will depend upon the flavor(s) selected, the flavor impression desired, and the form of the flavor component. Those skilled in the art, given the benefit of this disclosure, will be readily able to determine the amount of any particular flavor component(s) used to achieve the desired flavor impression.

Other flavorings suitable for use in at least certain exemplary embodiments of the beverage products disclosed here include, e.g., spice flavorings, such as mint, cassia, clove, cinnamon, pepper, ginger, vanilla spice flavorings, cardamom, coriander, root beer, sassafras, ginseng, and others. Numerous additional and alternative flavorings suitable for use in at least certain exemplary embodiments will be apparent to those skilled in the art given the benefit of this disclosure. Flavorings can be in the form of an extract, oleoresin, juice concentrate, bottler's base, or other forms known in the art. In at least certain exemplary embodiments, such spice or other flavors complement that of a juice or juice combination.

The one or more flavorings can be used in the form of an emulsion. A flavoring emulsion can be prepared by mixing some or all of the flavorings together, optionally together with other ingredients of the beverage, and an emulsifying agent. The emulsifying agent may be added with or after the flavorings mixed together. In certain exemplary embodiments the emulsifying agent is water-soluble. Exemplary suitable emulsifying agents include gum acacia, modified starch, carboxymethylcellulose, gum tragacanth, gum ghatti and other suitable gums. Additional suitable emulsifying agents will be apparent to those skilled in the art of beverage formulations, given the benefit of this disclosure. The emulsifier in exemplary embodiments comprises greater than about 3% of the mixture of flavorings and emulsifier. In certain exemplary embodiments the emulsifier is from about 5% to about 30% of the mixture.

Carbon dioxide can be used to provide effervescence to certain exemplary embodiments of the beverages disclosed here, such as frozen slush beverages, for instance. Any of the techniques and carbonating equipment known in the art for carbonating beverages can be employed. Carbon dioxide can enhance the beverage taste and appearance and can aid in safeguarding the beverage purity by inhibiting and destroying objectionable bacteria. In certain embodiments, for example, the beverage has a CO₂ level up to about 7.0 volumes carbon dioxide. Typical embodiments may have, for example, from about 0.5 to 5.0 volumes of carbon dioxide. As used here and independent claims, one volume of carbon dioxide is defined as the amount of carbon dioxide absorbed by any given quantity of water at 60° F. (16° C.) temperature and atmospheric pressure. A volume of gas occupies the same space as does the water by which it is absorbed. The carbon dioxide content can be selected by those skilled in the art based on the desired level of effervescence and the impact of the carbon dioxide on the taste or mouthfeel of the beverage. The carbonation can be natural or synthetic.

The juice beverages disclosed here may contain additional ingredients, including, generally, any of those typically found in beverage formulations. Examples of such additional ingredients include, but are not limited to, salt, caffeine, caramel and other coloring agents or dyes, antifoaming agents, gums, emulsifiers, tea solids, cloud components, and mineral and non-mineral nutritional supplements. Examples of non-mineral nutritional supplement ingredients are known to those of ordinary skill in the art and include, for example, antioxidants and vitamins, including Vitamins A, D, E (tocopherol), C (ascorbic acid), B₁ (thiamine), B₂ (riboflavin), B₃ (nicotinamide), B₄ (adenine), B₅ (pantothenic acid, calcium), B₆ (pyridoxine HCl), B₁₂ (cyanocobalamin), and K₁ (phylloquinone), niacin, folic acid, biotin, and combinations thereof. The optional non-mineral nutritional supplements are typically present in amounts generally accepted under good manufacturing practices. Exemplary amounts are between about 1% and about 100% RDV, where such RDV are established. In certain exemplary embodiments the non-mineral nutritional supplement ingredient(s) are present in an amount of from about 5% to about 20% RDV, where established.

### EXAMPLES

### Example 1

A reduced calorie not from concentrate (NFC) 100% juice orange juice beverage was prepared having the ingredients listed in Table 2 below. The specific amounts of each ingredient are also provided in the table, and the beverage looked and tasted like orange juice, but contained only 50 calories per 8 ounce serving, which is half of the calories of a typical NFC orange juice. In particular, the formulation exhibited a color of 37 OJ Index, which was within the standard of identity for NFC orange juice with respect to color.

The coconut water was a commercially available single strength not from concentrate coconut water (O.N.E., Los Angeles, Calif.). The orange solids were prepared by centrifuging not from concentrate Valencia orange juice on a commercial centrifuge system. The juice beverage was prepared by adding the orange solids to the coconut water. The juice beverage was rich in natural electrolytes provided by the coconut water, plus contained color, vitamins and flavonoids provided by the orange solids.

TABLE 2
Ingredients for a reduced calorie NFC orange juice beverage

| | Amount |
|---|---|
| | (wt % of total |
| Ingredient | beverage) |
| Coconut Water (6° brix) | 85 |
| Orange Solids—Sinking solids/bottom pulp | 15 |
| centrifuged from Valencia NFC OJ | |
| Citric acid | 0.23 |
| Orange Flavor | 0.12 |
| Reb A | 0.005% |

### Example 2

A reduced calorie from concentrate 100% juice orange juice beverage was prepared having the ingredients listed in Table 3 below. The specific amounts of each ingredient are also provided in the table, and the beverage looked and tasted like orange juice, but contained only 80 calories per 8 ounce serving, which is 20% less calories than in a typical NFC orange juice. In particular, the formulation exhibited a color of 37 OJ Index, which was within the standard of identity for NFC orange juice with respect to color.

The clarified carrot juice was a commercially available clarified and acidified carrot concentrate (Grimway Farms, Bakersfied, Calif.). The orange solids were prepared by centrifuging NFC valencia orange juice. The juice beverage was prepared by adding the orange solids to the clarified carrot concentrate. The juice beverage was rich in natural minerals and vitamins and color provided by the carrot concentrate, plus contained color, vitamins and flavonoids provided by the orange solids.

TABLE 3
Ingredients for a reduced calorie FC orange juice beverage

| | Amount |
|---|---|
| | (wt % of total |
| Ingredient | beverage) |
| Clarified Carrot Concentrate (7.6° brix) | 84 |
| Orange Solids—Centrifuged solids from | 15 |
| Valencia NFC OJ | |
| Citric Acid | 0.46 |
| Orange Flavor | 0.12 |

### Example 3

A reduced calorie 100% juice spicy grapefruit juice beverage was prepared having the ingredients listed in Table 4 below. The specific amounts of each ingredient are also provided in the table, and the beverage looked like grapefruit juice, but tasted like tomato juice and contained only 60 calories per 8 ounce serving. Grapefruit solids are not as flavorful as tomato, thus this example illustrates the concept of a juice beverage in which the taste is identifiable as the liquid derived from one or more fruits and/or vegetables, rather than being identifiable as the solids.

The tomato water was prepared by pureeing whole, ripe tomatoes, followed by removing the solids from the liquid. The grapefruit solids were prepared by centrifuging commercially available ruby red grapefruit juice (Tropicana, Bradenton, Fla.). The juice beverage was prepared by adding the ruby red grapefruit solids and spices to the tomato water. The juice beverage provided a full serving of vegetables from the tomato water, plus contained color and cloudiness, vitamins and flavonoids provided by the grapefruit solids.

TABLE 4
Ingredients for a reduced calorie spicy grapefruit juice beverage

| | Amount |
|---|---|
| | (volume % of total |
| Ingredient | beverage) |
| Tomato Water (5.0° brix) | 94 |
| Ruby Red Grapefruit Solids—Centrifuged | 5 |
| solids from ruby red grapefruit juice | |
| Spices (Black pepper, sweet chili pepper, | 1 |
| cayenne pepper, celery seed, oregano, | |
| cumin, basil, bay, marjoram, savory, thyme, | |
| coriander, mustard, rosemary, onion, garlic, | |
| orange peel, lemon oil) | |

### Example 4

A 100% juice tomato beverage was prepared having the ingredients listed in Table 5 below. The specific amounts of each ingredient are also provided in the table, and the beverage looked like tomato juice, but had the characteristic tangy kick of grapefruit juice to provide a more refreshing tomato juice. The beverage contained only 90 calories per 8 ounce serving.

The grapefruit serum was prepared by centrifuging Tropicana ruby red grapefruit juice. The tomato solids were prepared by pureeing whole, ripe tomatoes (Bionaturae, North Franklin, Conn.), followed by separating the solids from the liquid, and collecting the solids. The juice beverage was prepared by adding the tomato solids, mint and lime to the ruby red grapefruit serum. The juice beverage provided a full serving of fruit from the ruby red grapefruit serum, plus contained color, vitamins and other nutrients provided by the tomato solids.

TABLE 5
Ingredients for a low calorie tomato tonic beverage

| | Amount |
|---|---|
| | (wt % of total |
| Ingredient | beverage) |
| Ruby Red Grapefruit Serum (10.5° brix) | 65 |
| Tomato Solids (Bionaturae Organic | 34 |
| Strained Tomatoes - No Salt) | |
| Mint—Flavor Sensient | 0.05 |
| Salt | 0.06 |
| Lime—From Concentrate Lime Juice | 0.3 |

### Example 5

A 100% juice beverage was prepared having the ingredients listed in Table 6 below, to provide an economical juice beverage by combining an inexpensive juice as the bulk of the juice beverage with a small amount of a more expensive distinct fruit or vegetable component. Adding tomato solids to otherwise nutrient-poor (but inexpensive) apple juice provides for a more naturally nutrient-dense juice, including nutrients such as fiber, Vitamin A, and lycopene. The specific amounts of each ingredient are also provided in the table, and the beverage looked like tomato juice, but had the characteristic flavor of apple juice, without the acidity, saltiness, and thickness of regular tomato juice.

The apple juice serum was provided by NFC apple juice. The juice beverage provided a full serving of fruit from the apple juice, plus contained color, vitamins and other nutrients provided by the tomato solids.

TABLE 6
Ingredients for a value-added juice

| | Amount |
|---|---|
| | (vol % of total |
| Ingredient | beverage) |
| NFC Apple Juice | 88 |
| Tomato Solids (Bionaturae Organic | 12 |
| Strained Tomatoes - No Salt) | |

### Example 6

A 100% juice low-calorie lemonade was prepared having the ingredients listed in Table 7 below. Typically, lemonades made with juice comprise only about 10-13% juice as that is the maximum amount of lemon juice that can be included to provide the desired tartness, as any amount above approximately 13% would result in a lemonade that is too tart. One way to include more juice into a lemonade is to incorporate a low calorie juice, such as cucumber. The specific amounts of each ingredient are also provided in the table.

The cucumber serum was prepared by using commercially available clarified cucumber concentrate. The juice beverage looked like lemonade and had the characteristic flavor of lemonade, while providing a full serving of vegetable from the cucumber and a 100% juice from concentrate beverage.

TABLE 7
Ingredients for 100% Juice Lemonade

| | Amount |
|---|---|
| | (wt % of total |
| Ingredient | beverage) |
| Clarified cucumber concentrate (25° brix) | 12.1 |
| Erythritol | 2.5 |
| Reb A | 0.02 |
| Citric acid | 0.5 |
| Lemon flavor cloud | 0.2 |
| Lemon flavor | 0.2 |
| water | 84.98 |

Given the benefit of the above disclosure and description of exemplary embodiments, it will be apparent to those skilled in the art that numerous alternate and different embodiments are possible in keeping with the general principles of the invention disclosed here. Those skilled in this art will recognize that all such various modifications and alternative embodiments are within the true scope and spirit of the invention. The appended claims are intended to cover all such modifications and alternative embodiments. It should be understood that the use of a singular indefinite or definite article (e.g., “a,” “an,” “the,” etc.) in this disclosure and in the following claims follows the traditional approach in patents of meaning “at least one” unless in a particular instance it is clear from context that the term is intended in that particular instance to mean specifically one and only one. Likewise, the term “comprising” is open ended, not excluding additional items, features, components, etc.

1. A juice beverage comprising:
at least one liquid derived from one or more fruits, one or more vegetables, and combinations thereof and
solids derived from one or more fruits, one or more vegetables, and combinations thereof, wherein the solids are derived from one or more fruits or one or more vegetables distinct from the one or more fruits and one or more vegetables from which the liquid is derived,
wherein the taste of the beverage is identifiable as at least the one or more fruits or one or more vegetables from which the solids are derived, as determined by a sensory panel.

2. The juice beverage of claim 1, wherein the beverage meets the standard of identity of a 100% juice.

3. The juice beverage of claim 1, wherein the beverage comprises a brix of between about 3 degrees and about 16 degrees.

4. The juice beverage of claim 1, wherein the beverage comprises less than 100 calories per 8 ounce serving.

5. The juice beverage of claim 1, wherein the liquid comprises a juice, a serum, a juice concentrate, a clarified juice, a single strength juice, a not from concentrate juice, a fruit or vegetable water, and combinations thereof.

6. The juice beverage of claim 1, wherein the solids comprise sensible solids, sinking solids, vesicles, finisher-derived solids, pulp, sacs, pericarp, membranes, cellulosic materials, homogenized pulp, pomace, peel, and combinations thereof.

7. The juice beverage of claim 6, wherein the solids are isolated from the one or more fruits, one or more vegetables, or combinations thereof, using separation technology selected from the group consisting of centrifugation, decantation, filtration, nano-filtration, micro-filtration, and combinations thereof.

8. The juice beverage of claim 1, wherein the liquid comprises clarified carrot concentrate, tomato water, grapefruit serum, coconut water, cucumber serum, and combinations thereof.

9. The juice beverage of claim 1, wherein the solids comprise citrus solids, tomato solids, and combinations thereof.

10. The juice beverage of claim 9, wherein the citrus solids comprise orange solids, grapefruit solids, or a combination thereof.

11. The juice beverage of claim 4, wherein the beverage comprises less than 70 calories per 8 ounce serving.

12. The juice beverage of claim 1, wherein the beverage comprises a full serving of vegetables, a full serving of fruits, or a combination thereof, per 8 ounce serving.

13. The juice beverage of claim 1, further comprising a flavorant, selected from the group consisting of one or more spices, mint, lime and combinations thereof.

14. The juice beverage of claim 1, wherein the volume ratio of liquid to solids is from 2:1 to 30:1.

15. The juice beverage of claim 1, wherein the appearance of the juice beverage is identifiable as the juice of at least the one or more fruits or one or more vegetables from which the liquid is derived, as determined by a sensory panel.

16. The juice beverage of claim 1, wherein the solids are selected to provide predetermined macro nutrition, micro nutrition, or combinations thereof to the juice beverage.

17. A juice beverage comprising:
a juice selected from a fruit juice and a vegetable juice; and
solids obtained from a fruit or a vegetable, wherein the solids are obtained from a fruit or vegetable distinct from the fruit juice and the vegetable juice,
wherein the taste of the beverage is identifiable as at least the fruit or vegetable from which the solids are obtained, as determined by a sensory panel.

18. The juice beverage of claim 17, wherein the beverage meets the standard of identity of a 100% juice.

19. The juice beverage of claim 17, wherein the beverage comprises a brix of between about 3 degrees and about 16 degrees.

20. A method for making a beverage composition comprising:
combining at least one liquid derived from one or more fruits, one or more vegetables, and combinations thereof; and
solids derived from one or more fruits, one or more vegetables, and combinations thereof, wherein the solids are derived from one or more fruits or one or more vegetables distinct from the one or more fruits and one or more vegetables from which the liquid is derived,
wherein the taste of the beverage is identifiable as at least the one or more fruits or one or more vegetables from which the solids are derived, as determined by a sensory panel.

21. The method of claim 20, wherein the liquid comprises a juice, a serum, a juice concentrate, a clarified juice, a single strength juice, a not from concentrate juice, a fruit or vegetable water, and combinations thereof.

22. The method of claim 20, wherein the solids comprise sensible solids, sinking solids, vesicles, finisher-derived solids, pulp, sacs, pericarp, membranes, cellulosic materials, homogenized pulp, pomace, peel, and combinations thereof.

23. The method of claim 22, wherein the solids are isolated from the one or more fruits, one or more vegetables, or combinations thereof, using separation technology selected from the group consisting of centrifugation, decantation, filtration, nano-filtration, micro-filtration, and combinations thereof.

24. The method of claim 20, wherein the solids are selected to provide predetermined macro nutrition, micro nutrition, or combinations thereof to the juice beverage.

25. The method of claim 20, wherein the beverage comprises a brix of between about 3 degrees and about 16 degrees.

26. The method of claim 20, wherein the beverage meets the standard of identity of a 100% juice.

27. A juice beverage comprising:
at least one liquid derived from one or more fruits, one or more vegetables, and combinations thereof; and
solids derived from one or more fruits, one or more vegetables, and combinations thereof, wherein the solids are derived from one or more fruits or one or more vegetables distinct from the one or more fruits and one or more vegetables from which the liquid is derived,
wherein the taste of the beverage is identifiable as at least the one or more fruits or one or more vegetables from which the liquid is derived, as determined by a sensory panel.

28. The juice beverage of claim 27, wherein the beverage meets the standard of identity of a 100% juice.

29. The juice beverage of claim 27, wherein the beverage comprises a brix of between about 3 degrees and about 16 degrees.
